(19) United States
(12) Patent Application Publication
(10) Pub. No.: US 2004/0102301 A1
(43) Pub. Date: May 27, 2004

(54) Buckle-folding unit for a folding machine

(75) Inventor: Stefan Szczerba, Murrhardt (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/715,445

(22) Filed: Nov. 19, 2003

(30) Foreign Application Priority Data
Nov. 22, 2002 (DE) 202 18 159.6

(51) Int. Cl. B31F 7/00

(52) U.S. Cl. 493/419

(57) ABSTRACT

A buckle-folding unit for a folding machine has at least one buckle plate (10) including a plurality of plate-bar structures (12) which are spaced apart one beside the other in a single plane, each of the plate-bar structures (12) including two plate bars (14, 16) spaced apart from one another to form a gap (18) therebetween, the gaps (18) being located in a single plane. The plate bars (14, 16) have an inner recess (33) in the side thereof which is directed toward the gap (18). A sheet-stopping device (22), which can be displaced in the longitudinal direction of the plate-bar structures (12), is arranged transversely to the plate-bar structures (12) and passes through the gaps (18) of the plate-bar structures (12). The sheet-stopping device (22) has a plurality of outer stops (26), each of the outer stops (26) being arranged between adjacent plate-bar structures (12), and a plurality of inner stops (34), which are arranged within the plate-bar structures (12), each of the inner stops (34) extending into an inner recess of the plate bars (12, 14). The inner stops (34) are connected to adjacent outer stops (26) via a connecting crosspiece (34), the width (b) of the connecting crosspiece (34), in the direction perpendicular to the plane of the gaps (18), being smaller than the height of the gap (18).

### FIELD OF THE INVENTION

The invention relates to a buckle-folding unit for a folding machine, having at least one buckle plate which has a plurality of plate-bar means or structures which are spaced apart one beside the other in a single plane and each comprise two plate bars which, in order to form a gap between them, are spaced apart from one another, it being the case that the plate bars have an inner recess in their side which is directed toward the gap, a sheet-stopping device, which can be displaced in the longitudinal direction of the plate-bar structures and is arranged transversely to the plate-bar structures, passes through the gaps, located in a single plane, of the adjacent plate-bar structures, and the sheet-stopping device has a plurality of stops which are arranged in each case between adjacent plate-bar structures.

### DESCRIPTION OF THE BACKGROUND ART

FIG. 3 shows a cross section of a known buckle-folding unit which has a buckle plate 110 with a plurality of adjacent plate-bar structures 112, each plate-bar device 112 being formed by two vertically spaced-apart plate bars 114, 116. A gap is formed between the plate bars 114, 116, and a sheet which is to be folded runs into the gap. A sheet stop 122 passes through the gaps of the adjacent plate-bar structures 112, which together form a gap, the width b of the sheet stop corresponding to the spacing between the plate bars 114, 116, that is to say the height of the gap. The sheet stop 122 can be displaced in the longitudinal direction of the plate-bar structures 112 in order that the buckle plate 110 can be set to the necessary sheet length. Since the sheet stop 122 has a constant width and passes through the gaps, the sheet stop 122 has a large continuous sheet-stopping surface, as a result of which, even when the buckle-folding unit operates at high capacity, no tearing of the leading sheet edges takes place.

Since the width b of the sheet stop 122 corresponds to the height of the gaps, however, it is not possible to set the distance between the plate bars 114, 116 and thus the height of the gap. Such a setting, however, is necessary in order to minimize, in dependence on the sheet thickness and type of folding, the formation of corrugations in the sheets as they come up against a stop, in order that only small longitudinal-folding differences occur.

For this reason, it has become common to use a buckle plate 210 as is shown in FIG. 4. The buckle plate 210 has a sheet stop 222 which comprises an adjustable base plate 224 which is located beneath the plate-bar structures 212, in the longitudinal direction of the plate bars 214, 216, and from the free end of which stops 226 extend beyond the height of the gaps 218 into the interspace between two adjacent plate-bar structures 212. This makes it possible for the height of the gap 218 to be set to the nature of a sheet by virtue of the top or bottom plate bar 214, 216 being adjusted. It is disadvantageous, however, that there is no continuous sheet-stopping surface provided, since the stops 226 are spaced apart from one another. This may result, when the buckle-folding unit operates at high capacity, in the leading sheet edge tearing, as a result of which, once again, longitudinal-folding differences may occur.

### SUMMARY OF THE INVENTION

The object of the invention is to provide a buckle-folding unit which, even at high capacity, allows folding with only small longitudinal-folding differences and without the leading sheet edge tearing.

This object is achieved according to the invention by a buckle-folding having at least one buckle plate including a plurality of plate-bar structures which are spaced apart one beside the other in a single plane, each of the plate-bar including two plate bars spaced apart from one another to form a gap therebetween, the gaps being located in a single plane, wherein the plate bars have an inner recess in the side thereof which is directed toward the gap, a sheet-stopping device, which can be displaced in the longitudinal direction of the plate-bar structures, is arranged transversely to the plate-bar structures and passes through the gaps of the plate-bar structures, the sheet-stopping device has a plurality of outer stops, each of the outer stops being arranged between adjacent plate-bar structures, and a plurality of inner stops, which are arranged within the plate-bar structures, each of the inner stops into an inner recess of the plate bars, and the inner stops are connected to adjacent outer stops via a connecting crosspiece, the width of the connecting crosspiece, in the direction perpendicular to the plane of the gaps, being smaller than the height of the gap.

In the buckle-folding unit according to the present invention, the sheet-stopping device forms a largely continuous sheet-stopping surface which is only interrupted in the region of the very short connecting crosspieces. Since the width of the connecting crosspieces, in the direction perpendicular to the plane of the gaps, is smaller than the height of the gap, it is possible to set the height of the gap in accordance with the nature of the incoming sheets, as a result of which the formation of corrugations in the sheets as they come up against stops is prevented, as is tearing of the leading sheet edge as it comes up against a stop.

### BRIEF DESCRIPTION OF THE DRAWINGS

An exemplary embodiment of the invention is explained in more detail hereinbelow with reference to drawings, in which:

FIG. 1 shows a partial longitudinal section through a buckle plate of a buckle-folding unit,

FIG. 2 shows the section II-II from FIG. 1,

FIG. 3 shows a cross section through a first known buckle plate of a buckle-folding unit, and

FIG. 4 shows a cross section through a second known buckle plate of a buckle-folding unit.

### DETAILED DESCRIPTION OF THE INVENTION

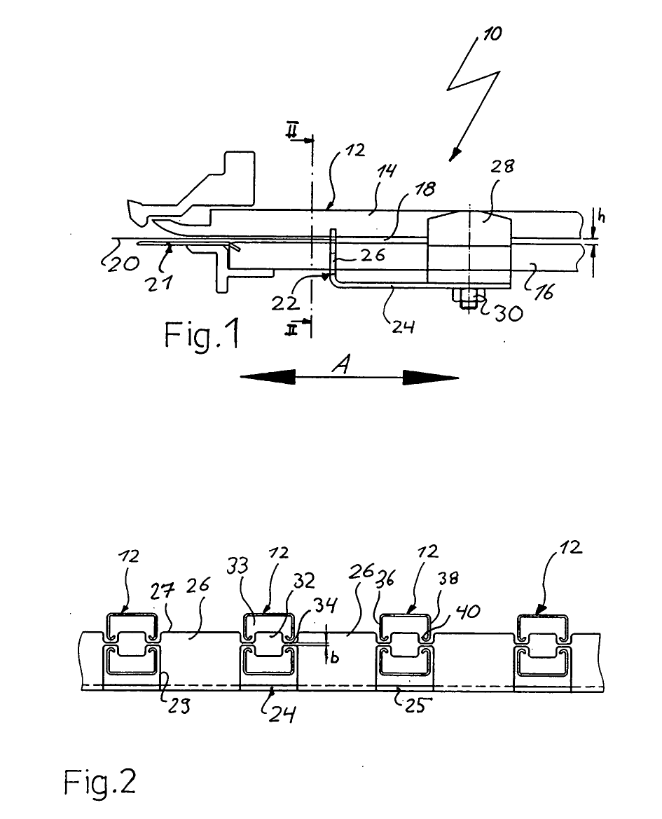

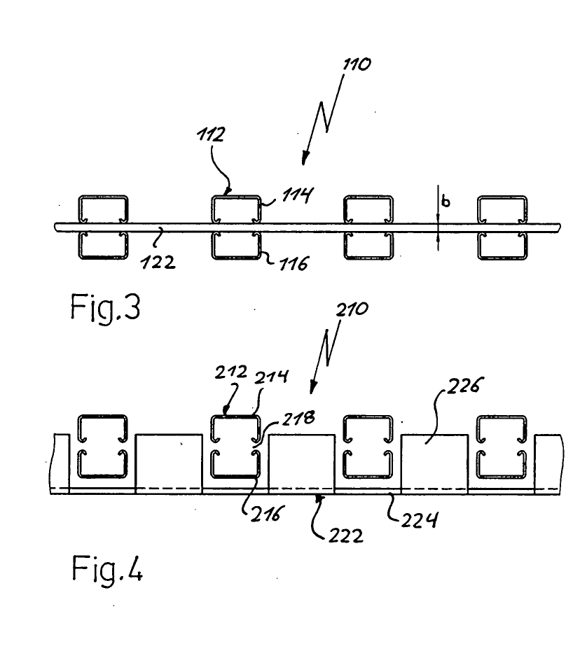

The buckle plate 10 which is shown in FIG. 1 has a plurality of parallel plate-bar structures 12 which are uniformly spaced apart from one another in a single plane. Each plate-bar device 12 comprises a top plate bar 14 and a bottom plate bar 16, which are spaced apart one above the other, parallel to one another, as a result of which a gap 18 of height h is formed between the plate bars 14, 16. The gaps 18 of the adjacent plate-bar structures together form the gap of the buckle plate 10. Each plate bar 14, 16 is formed by a U-shaped bent metal profile, the free legs 36, 38, which are directed toward the gap 18, being bent inward at their ends to form a curve 40.

Provided at the left-hand of each plate-bar device 12, as seen in FIG. 1, is a sheet inlet 21 for a sheet 20 which is to be folded to run into the gap 18.

The buckle plate 10, furthermore, has a sheet-stopping device 22, which can be adjusted in the longitudinal direction of the plate-bar structures 12. The sheet-stopping device 22 comprises a base plate 24 arranged beneath the bottom plate bars 16. The base plate 24 extends, transversely to the longitudinal direction of the plate-bar structures 12, parallel to, and at a spacing from, the bottom plate bars 16. On its side which is directed away from the sheet inlet, the base plate 24 is fastened by structures of a screw connection 30, on a guide block 28, which is guided in a displaceable manner in the longitudinal direction of the plate-bar structures 12. From the side border 25 of the base plate 24, the border being directed toward the sheet inlet 21 and running at right angles to the longitudinal direction of the plate-bar structures 12, outer stops 26 extend perpendicularly upward in each case into the interspace between two adjacent plate-bar structures 12. The outer stops 26 are essentially rectangular, the top edge 27, which runs parallel to the base plate 24, being located above the gaps 18. The side borders 29, which run perpendicularly to the base plate 24, are adjacent to the plate bars 14, 16.

An additional inner stopping surface 32 is provided within the plate-bar structures 12. The inner stopping surface 32 is in the form of a rectangular plate and is arranged in the plane of the outer stopping surfaces 26. The top and the bottom borders of the inner stopping surface 32 extend into the interior 33 of the top plate bar 14 and of the bottom plate bar 16. The side borders of the inner stopping surface 32, which run perpendicularly to the base plate 24, are each connected, level with the gap 18, to the facing side border of the adjacent outer stopping surface 26 via a connecting crosspiece 34, which extends parallel to the base plate 24. The width b of the connecting crosspieces 34, in the direction perpendicular to the plane running through the gaps 18, is smaller than the height h of the gaps 18, as a result of which it is possible to set the height h of the gap 18. The inner stopping surfaces 32 and the outer stopping surfaces 26 form an essentially continuous stopping surface which is interrupted merely by the connecting crosspieces 34. Furthermore, it is possible to set the height h of the gaps 18, the minimum dimension of the height being determined by the thickness b of the connecting crosspieces 34.

In the case of a preferred embodiment of the buckle-folding unit, the thickness b of the connecting crosspieces 34 is 1 mm and the height h of the gaps 18 is 1 mm≦h≦3.5 mm.

1. A buckle-folding unit for a folding machine, having at least one buckle plate including a plurality of plate-bar structures which are spaced apart one beside the other in a single plane, each of the plate-bar structures including two plate bars spaced apart from one another to form a gap therebetween, the gaps being located in a single plane, wherein
the plate bars have an inner recess in the side thereof which is directed toward the gap,
a sheet-stopping device, which can be displaced in the longitudinal direction of the plate-bar structures, is arranged transversely to the plate-bar structures and passes through the gaps of the plate-bar structures,
the sheet-stopping device has a plurality of outer stops, each of the outer stops being arranged between adjacent plate-bar structures, and a plurality of inner stops, which are arranged within the plate-bar structures, each of the inner stops extending into an inner recess of the plate bars, and
the inner stops are connected to adjacent outer stops via a connecting crosspiece, the width of the connecting crosspiece, in the direction perpendicular to the plane of the gaps, being smaller than the height of the gap.
